(19) United States
(12) Patent Application Publication
(10) Pub. No.: US 2020/0120506 A1
(43) Pub. Date: Apr. 16, 2020

(54) METHOD AND APPARATUS FOR DETECTING ROGUE ACCESS POINT IN WIRELESS NETWORKS

(71) Applicant: QUALCOMM Incorporated, San Diego, CA (US)

(72) Inventor: Sathish Kumar KANNAN, Chennai (IN)

(21) Appl. No.: 16/160,916

(22) Filed: Oct. 15, 2018

(51) Int. Cl. H04W 12/08; H04W 12/06

(52) U.S. Cl. CPC H04W 12/08; H04W 84/12; H04W 12/06

(57) ABSTRACT

Certain aspects relate to methods, apparatuses, computer readable mediums, wireless nodes, and wireless devices. For example, an apparatus generally includes a processing system configured to obtain a first packet from a wireless node, said first packet indicating the wireless node is authorized to communicate within a network; determine whether the wireless node is authorized to communicate within the network based on the first packet and a second packet, wherein the second packet is associated with an authorized wireless node; and generate an indication if the determination indicates the first packet and the second packet do not match. The apparatus also includes an interface configured to output the indication for transmission.

### BACKGROUND

### Field

The present disclosure generally relates to communications networks, and more particularly, to method and apparatus for detecting a rogue access point in wireless networks.

### Background

Wireless communication networks are widely deployed to provide various communication services such as telephony, video, data, messaging, broadcasts, and so on. Such networks, which are usually multiple access networks, support communications for multiple users by sharing the available network resources.

These wireless communication networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks and Wi-Fi networks.

Within such wireless communication networks, a variety of data services may be provided, including voice, video, and emails. More recently, wireless communication networks are being used for an even broader range of services and larger numbers of users. As the demand for mobile broadband access continues to increase, research and development continue to advance wireless communication technologies not only to meet the growing demand for mobile broadband access, but to advance and enhance the user experience.

A wireless local area network (WLAN) connects two or more devices using radio waves. These devices may be categorized as being either an access point (AP) or a client, the latter also referred to herein as a client station or, simply, station (STA). A single service set consists of all STAs associated with a given AP and is referred to as a basic service set (B SS), with the most basic BSS configuration consisting of one AP and one STA. Multiple BSSs, using a common service set identifier (SSID), may form an extended service set (ESS). These BSSs may all operate using the same or different channels. In addition to using APs that are connected to each other through a wired network, the WLAN may be implemented using mesh network technologies.

A rogue AP (RAP) is a wireless AP that has been installed on a secure network without explicit authorization from a local network administrator, whether added by a well-meaning employee or by a malicious attacker. RAPs pose serious security issues in a WLAN. Among various types of RAPs, a “fake AP,” which is an AP having a fully forged SSID and MAC address of a legitimate AP, is understood to be hardest type of RAP to detect and poses the highest threat to network security.

Existing approaches to detecting RAPs rely on packet statistics such as beacon sequence number, timestamp, and signal strength. However, hackers can deliberately synchronize parameters such as these on fake APs using information obtained from legitimate APs and thereby escape RAP detection algorithms that solely depend on packet statistics.

As the demand for wireless network access continues to increase, research and development continue to advance communications technologies not only to meet the growing demand for wireless network access, but to advance and enhance security of these networks. Thus, it would be useful to address the issues presented above.

### SUMMARY

The systems, networks, methods, devices and apparatuses of the disclosure each have several aspects. No single one of the aspects is solely responsible for desirable attributes of such systems, networks, methods, devices and apparatuses. Without limiting the scope of this disclosure as expressed by the claims which follow, some aspects will now be discussed briefly. After considering this discussion, and particularly after reading the section entitled “Detailed Description” one will understand how the aspects of this disclosure provide advantages that include improved security in the communications between wireless nodes in a wireless network.

Certain aspects of the disclosure provide an apparatus for wireless communication, including a processing system configured to obtain a first packet from a wireless node, the first packet indicating the wireless node is authorized to communicate within a network; determine whether the wireless node is authorized to communicate within the network based on the first packet and a second packet, wherein the second packet is associated with an authorized wireless node; and generate an indication if the determination indicates the first packet and the second packet do not match. The apparatus also includes an interface configured to output the indication for transmission.

Certain aspects of the disclosure provide an apparatus for wireless communication, including a processing system configured to generate a packet; and generate a copy of the packet. The apparatus also includes an interface configured to output the packet for transmission to an authorized wireless node and the copy of the packet for transmission to a packet storage remotely located from the apparatus.

Certain other aspects of the disclosure provide a method for wireless communication, including obtaining a first packet from a wireless node, the first packet indicating the wireless node is authorized to communicate within a network; determining whether the wireless node is authorized to communicate within the network based on the first packet and a second packet, wherein the second packet is associated with an authorized wireless node; generating an indication if the determination indicates the first packet and the second packet do not match; and outputting the indication for transmission.

Certain other aspects of the disclosure provide a method for wireless communication, including generating a packet; generating a copy of the packet; and outputting the packet for transmission to an authorized wireless node and the copy of the packet for transmission to a remotely located packet storage.

Certain other aspects of the disclosure provide an apparatus for wireless communication, including means for obtaining a first packet from a wireless node, said first packet indicating the wireless node is authorized to communicate within a network; means for determining whether the wireless node is authorized to communicate within the network based on the first packet and a second packet, wherein the second packet is associated with an authorized wireless node; means for generating an indication if the determination indicates the first packet and the second packet do not match; and means for outputting the indication for transmission.

Certain other aspects of the disclosure provide an apparatus for wireless communications, including means for generating a packet; means for generating a copy of the packet; and means for outputting the packet for transmission to an authorized wireless node and the copy of the packet for transmission to a packet storage remotely located from the apparatus.

Certain other aspects of the disclosure provide a computer-readable medium, including code for obtaining a first packet from a wireless node, the first packet indicating the wireless node is authorized to communicate within a network; determining whether the wireless node is authorized to communicate within the network based on the first packet and a second packet, wherein the second packet is associated with an authorized wireless node; generating an indication if the determination indicates the first packet and the second packet do not match; and outputting the indication for transmission.

Certain other aspects of the disclosure provide a computer-readable medium including code for generating a packet; generating a copy of the packet; and outputting the packet for transmission to an authorized wireless node and the copy of the packet for transmission to a remotely located packet storage.

Certain other aspects of the disclosure provide a wireless device, including a processing system configured to obtain a first packet from a wireless node, said first packet indicating the wireless node is authorized to communicate within a network; determine whether the wireless node is authorized to communicate within the network based on the first packet and a second packet, wherein the second packet is associated with an authorized wireless node; and generate an indication if the determination indicates the first packet and the second packet do not match. The wireless device further includes a transmitter configured to transmit the indication.

Certain other aspects of the disclosure provide an access point, including a processing system configured to generate a packet; and generate a copy of the packet. The access point further includes a transmitter configured to transmit the packet to an authorized wireless node and transmit the copy of the packet to a packet storage remotely located from the apparatus.

Aspects generally include methods, apparatuses, computer readable mediums, wireless nodes, and wireless devices as substantially described herein with reference to and as illustrated by the accompanying drawings. Numerous other aspects are provided.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

These and other aspects of the invention will become more fully understood upon a review of the detailed description, which follows.

### BRIEF DESCRIPTION OF THE DRAWINGS

These and other sample aspects of the disclosure will be described in the detailed description that follow, and in the accompanying drawings.

FIG. 1 is a diagram of an example wireless communications network configured in accordance with certain aspects of the present disclosure.

FIG. 2 is a block diagram of an example access point and example stations configured in accordance with certain aspects of the present disclosure.

FIG. 3 is a block diagram of an example wireless device configured in accordance with certain aspects of the present disclosure.

FIG. 4 is a diagram of another example wireless communications network in which certain aspects of the present disclosure may be understood.

FIG. 5 is a diagram of the example wireless communications network of FIG. 4 that includes a rogue AP (RAP).

FIG. 6 is a diagram of a transmitted packet capture and storage architecture that may be used for the present disclosure.

FIG. 7 is a flow diagram of an example operation of an AP that may be used in the present disclosure to detect RAPs.

FIG. 8 is a diagram of an RAP monitor that may be used in the present disclosure to detect RAPs.

FIG. 9 is a diagram of an RAP monitor that may be included in APs and used in the present disclosure to detect RAPs.

FIG. 10 is a flow diagram of an example operation of an RAP monitor in the present disclosure to detect RAPs.

FIG. 11 and FIG. 12 are diagrams that may be used to describe various aspects of the present disclosure for detecting RAPs.

FIG. 13 and FIG. 14 are diagrams that may be used to describe various aspects of the present disclosure for transmitted packet capture and storage.

To facilitate understanding, identical reference numerals have been used, where possible, to designate identical elements that are common to the figures. It is contemplated that elements disclosed in one aspect may be beneficially used on other aspects without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced, using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

The word “communicate” is used herein to mean “transmit”, “receive” or “transmit and receive”. The word “communications” is used herein to mean “transmission”, “reception” or “transmission and reception”.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The following description is directed to certain implementations for the purposes of describing the innovative aspects of this disclosure. However, a person having ordinary skill in the art will readily recognize that the teachings herein can be applied in different ways and may be incorporated into various types of communication networks or network components. In some aspects, the teachings herein may be employed in a multiple-access network capable of supporting communication with multiple users by sharing the available network resources (e.g., by specifying one or more of bandwidth, transmit power, coding, interleaving, and so on). For example, the teachings herein may be applied to any one or combinations of the following technologies or standards: Code Division Multiple Access (CDMA), Multiple-Carrier CDMA (MCCDMA), Wideband CDMA (W-CDMA), Time Division Multiple Access (TDMA), Frequency Division Multiple Access (FDMA), Single-Carrier FDMA (SC-FDMA), Orthogonal Frequency Division Multiple Access (OFDMA), IS-95, cdma2000, IS-856, W-CDMA, TDSCDMA, 802.11 (Wi-Fi), 802.16, Global System for Mobile Communication (GSM), Evolved UTRA (E-UTRA), IEEE 802.20, Flash-OFDM®, Long Term Evolution (LTE), Ultra-Mobile Broadband (UMB), Ultra-Wide Band (UWB), Bluetooth®, GSM/General Packet Radio Service (GPRS), Enhanced Data GSM Environment (EDGE), Terrestrial Trunked Radio (TETRA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), AMPS, or other technology of 3G, 4G, or 5G.

The techniques may be incorporated into (such as implemented within or performed by) a variety of wired or wireless apparatuses (such as nodes or devices). In some implementations, a node includes a wireless node, which may also be referred to as a wireless device. Such a wireless node may provide, for example, connectivity to or for a network [such as a wide area network (WAN) such as the Internet or a cellular network] via a wired or wireless communications link In some implementations, a wireless node may be an access point or a user terminal. The various examples of wireless nodes (or wireless devices) described herein may also be embodied in a device referred to as a “monitor device” or, simply, a “monitor.”

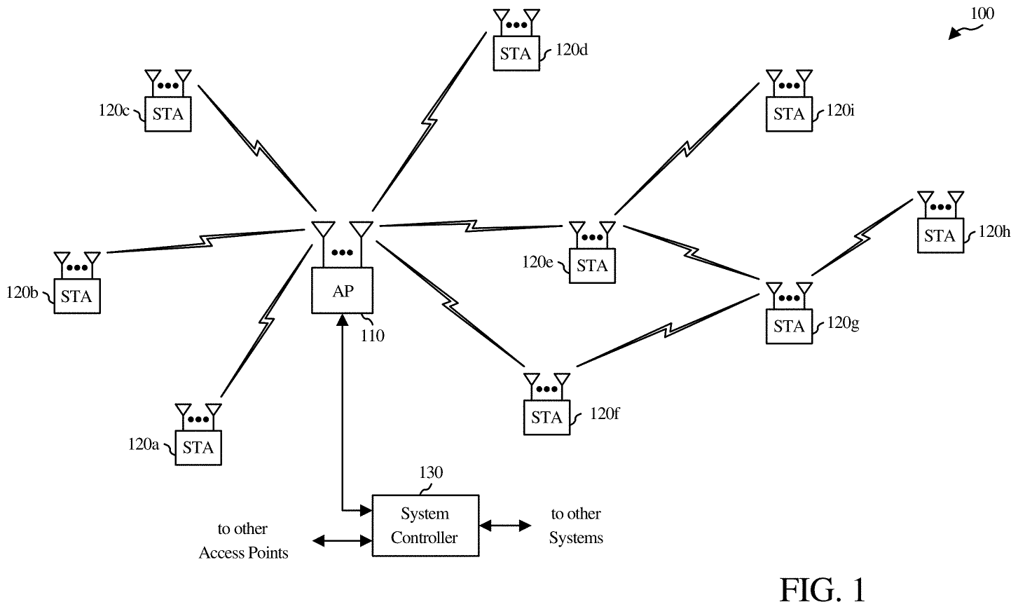

FIG. 1 illustrates a multiple-access Multiple Input Multiple Output (MIMO) network 100 with access points and user terminals. For simplicity, only one access point 110 is shown in FIG. 1. An access point (AP) is generally a fixed station that communicates with the user terminals and also may be referred to as a base station or some other terminology. A user terminal may be fixed or mobile and also may be referred to as a mobile station, an access terminal, a station (STA), a client, user equipment or some other terminology. A user terminal may be a cellular phone, a personal digital assistant (PDA), a handheld device, a wireless modem, a laptop computer, a personal computer, etc.

The access point 110 may communicate with one or more user terminals or stations 120 at any given moment on the downlink and uplink The downlink (i e , forward link) is the communications link from the access point to the user terminals, and the uplink (i.e., reverse link) is the communications link from the user terminals to the access point. A user terminal also may communicate peer-to-peer with another user terminal. A network controller 130 couples to and provides coordination and control for the access points.

The MIMO network 100 employs multiple transmit and multiple receive antennas for data transmission on the downlink and uplink The access point 110 is equipped with a number Nₐₚ of antennas and represents the multiple-input (MI) for downlink transmissions and the multiple-output (MO) for uplink transmissions. A set Nᵤ of selected user terminals 120 collectively represents the multiple-output for downlink transmissions and the multiple-input for uplink transmissions. In some implementations, it may be desirable to have Nₐₚ≥Nᵤ≥1 if the data symbol streams for the Nᵤ user terminals are not multiplexed in code, frequency or time by some means. Nᵤ may be greater than Nₐₚ if the data symbol streams can be multiplexed using different code channels with CDMA, disjoint sets of sub-bands with OFDM, and so on. Each selected user terminal transmits user-specific data to and receives user-specific data from the access point. In general, each selected user terminal may be equipped with one or multiple antennas (i.e., Nᵤₜ≥1). The Nᵤ selected user terminals can have the same or different number of antennas.

The MIMO system or network 100 may be a time division duplex (TDD) network or a frequency division duplex (FDD) network. For a TDD network, the downlink and uplink share the same frequency band. For an FDD network, the downlink and uplink use different frequency bands. The MIMO network 100 also may use a single carrier or multiple carriers for transmission. Each user terminal may be equipped with a single antenna (such as in order to keep costs down) or multiple antennas (such as where the additional cost can be supported). The MIMO network 100 may represent a high-speed Wireless Local Area Network (WLAN) operating in a 60 GHz band.

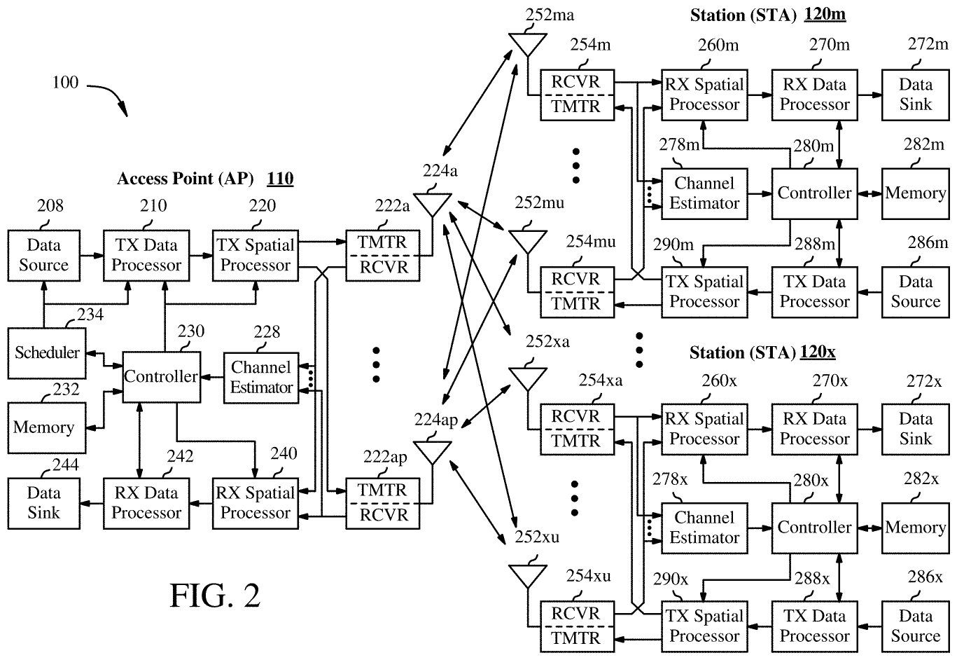

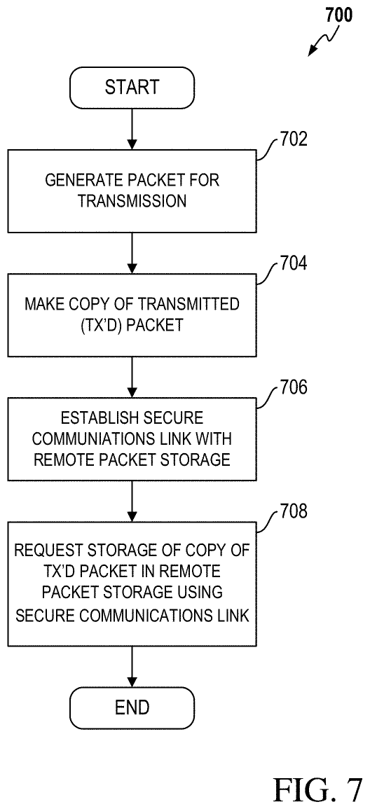

FIG. 2 illustrates example components of the access point 110 and user terminal or station 120 illustrated in FIG. 1, which may be used to implement aspects of the present disclosure. One or more components of the access point 110 and station 120 may be used to practice aspects of the present disclosure. For example, antenna 224, transmitter/receiver unit 222, processors 210, 220, 240, 242, and/or controller 230 or antenna 252, transmitter/receiver 254, processors 260, 270, 288, and 290, and/or controller 280 may be used to perform the operations described herein and illustrated with reference to the figures, such as FIGS. 7, 10, 11, 12, 13, and 14.

FIG. 2 shows a block diagram of the access point/base station 110 and two user terminals 120m and 120x in a MIMO network 100. The access point 110 is equipped with Nₐₚ antennas 224a through 224ap. The user terminal 120m is equipped with N_{ut,m} antennas 252ma through 252mu, and the user terminal 120x is equipped with N_{ut,x} antennas 252xa through 252xu. The access point 110 is a transmitting entity for the downlink and a receiving entity for the uplink Each user terminal 120 is a transmitting entity for the uplink and a receiving entity for the downlink As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, and N_{dn} user terminals are selected for simultaneous transmission on the downlink Moreover, Nᵤₚ may or may not be equal to N_{dn}, and Nᵤₚ, and N_{dn} may include static values or can change for each scheduling interval. Beamforming (such as beam-steering) or some other spatial processing techniques may be used at the access point and user terminal.

On the uplink, at each user terminal 120 selected for uplink transmission, a TX data processor 288 receive traffic data from a data source 286 and control data from a controller 280. The controller 280 may be coupled with a memory 282. The TX data processor 288 processes (such as encodes, interleaves, and modulates) the traffic data {d_{up,m}} for the user terminal based on the coding and modulation schemes associated with the rate selected for the user terminal and provides a data symbol stream {S_{up,m}}. A TX spatial processor 290 performs spatial processing on the data symbol stream {S_{up,m}} and provides N_{ut,m} transmit symbol streams for the N_{ut,m} antennas. Each transmitter unit (TMTR) 254 receives and processes (such as converts to analog, amplifies, filters, and frequency upconverts) a respective transmit symbol stream to generate an uplink signal. The N_{ut,m} transmitter units 254 provide N_{ut,m} uplink signals for transmission from the N_{ut,m} antennas 252 to the access point 110.

A number Nᵤₚ of user terminals may be scheduled for simultaneous transmission on the uplink. Each of these user terminals performs spatial processing on its data symbol stream and transmits its set of transmit symbol streams on the uplink to the access point.

At the access point 110, the Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by the transmitter unit 254 and provides a received symbol stream. An RX spatial processor 240 performs receiver spatial processing on the Nₐₚ received symbol streams from the Nₐₚ receiver units 222 and provides Nᵤₚ recovered uplink data symbol streams The receiver spatial processing is performed in accordance with the channel correlation matrix inversion (CCMI), minimum mean square error (MMSE), successive interference cancellation (SIC), or some other technique. Each recovered uplink data symbol stream {s_{up,m}} is an estimate of a data symbol stream {s_{up,m}} transmitted by a respective user terminal. An RX data processor 242 processes (such as demodulates, de-interleaves, and decodes) each recovered uplink data symbol stream {s_{up,m}} in accordance with the rate used for that stream to obtain decoded data. The decoded data for each user terminal may be provided to a data sink 244 for storage and a controller 230 for further processing.

On the downlink, at the access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. The TX data processor 210 processes (such as encodes, interleaves, and modulates) the traffic data for each user terminal based on the rate selected for that user terminal. The TX data processor 210 provides N_{dn} downlink data symbol streams for the N_{dn} user terminals. A TX spatial processor 220 performs spatial processing on the N_{dn} downlink data symbol streams, and provides Nₐₚ transmit symbol streams for the Nₐₚ antennas. Each transmitter unit (TMTR) 222 receives and processes a respective transmit symbol stream to generate a downlink signal. The Nₐₚ transmitter units 222 provide Nₐₚ downlink signals for transmission from the Nₐₚ antennas 224 to the user terminals. The decoded data for each STA may be provided to a data sink 272 for storage and/or a controller 280 for further processing.

At each user terminal 120, the N_{ut,m} antennas 252 receive the Nₐₚ downlink signals from the access point 110. Each receiver unit (RCVR) 254 processes a received signal from an associated antenna 252 and provides a received symbol stream. An RX spatial processor 260 performs receiver spatial processing on N_{ut,m} received symbol streams from the N_{ut,m} receiver units 254 and provides a recovered downlink data symbol stream {s_{dn,m}} for the user terminal. The receiver spatial processing can be performed in accordance with the CCMI, MMSE, or other known techniques. An RX data processor 270 processes (such as demodulates, de-interleaves, and decodes) the recovered downlink data symbol stream to obtain decoded data for the user terminal

At each user terminal 120, the N_{ut,m} antennas 252 receive the Nₐₚ downlink signals from the access point 110. Each receiver unit (RCVR) 254 processes a received signal from an associated antenna 252 and provides a received symbol stream. An RX spatial processor 260 performs receiver spatial processing on N_{ut,m} received symbol streams from the N_{ut,m} receiver units 254 and provides a recovered downlink data symbol stream {s_{dn,m}} for the user terminal. The receiver spatial processing is performed in accordance with the CCMI, MMSE, or some other technique. An RX data processor 270 processes (such as demodulates, de-interleaves, and decodes) the recovered downlink data symbol stream to obtain decoded data for the user terminal

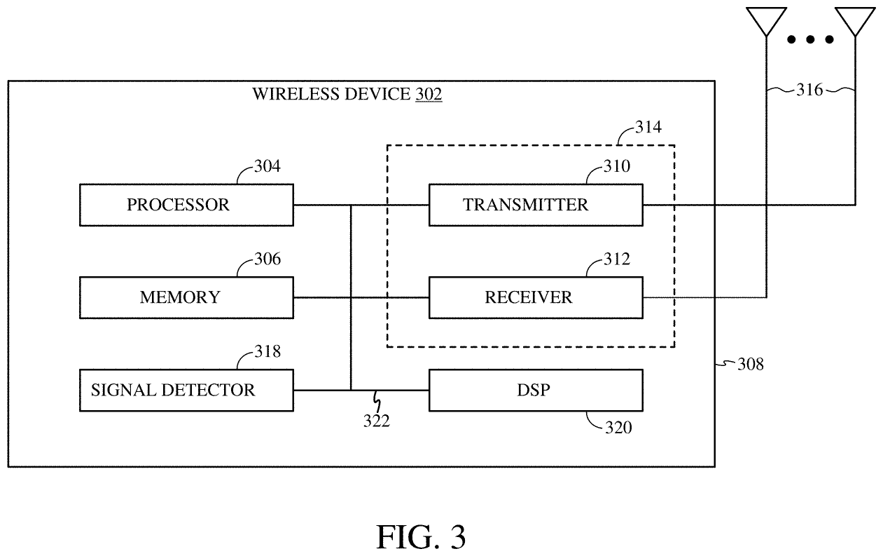

FIG. 3 illustrates various components that may be used in a wireless device 302 that may be employed within the MIMO network 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 also may be referred to as a central processing unit (CPU). Memory 306, which may include both read-only memory (ROM) and random-access memory (RAM), provides instructions and data to the processor 304. A portion of the memory 306 also may include non-volatile random-access memory (NVRAM). The processor 304 typically performs logical and arithmetic operations based on program instructions stored within the memory 306. The instructions in the memory 306 may be executable to implement the methods described herein.

The wireless device 302 also may include a housing 308 that may include a transmitter 310 and a receiver 312 to allow transmission and reception of data between the wireless device 302 and a remote location. The transmitter 310 and the receiver 312 may be combined into a transceiver 314. A plurality of transmit antennas 316 may be attached to the housing 308 and electrically coupled to the transceiver 314. The wireless device 302 also may include (not shown) multiple transmitters, multiple receivers, and multiple transceivers.

The wireless device 302 also may include a signal detector 318 that may be used in an effort to detect and quantify the level of signals received by the transceiver 314. The signal detector 318 may detect such signals as total energy, energy per subcarrier per symbol, power spectral density and other signals. The wireless device 302 also may include a digital signal processor (DSP) 320 for use in processing signals.

The various components of the wireless device 302 may be coupled together by a bus system 322, which may include a power bus, a control signal bus, and a status signal bus in addition to a data bus.

Various aspects of the present disclosure are applicable to WLANs defined by IEEE 802.11. In addition, various aspects of the present disclosure are applicable to wireless mesh networks, such as those provided by IEEE 802.11s. These aspects provide for detection of a rogue AP (RAP) that will exactly detect RAPs—even in scenarios where hackers synchronize packet statistics on the RAPs with APs that belong to the WLAN (i.e., APs that are authorized to communicate within the network). These APs may be referred to as authorized APs, managed APs, or authorized wireless nodes. In contrast, the RAPs are wireless nodes that are not authorized to communicate within the network and may be referred to as unauthorized wireless nodes.

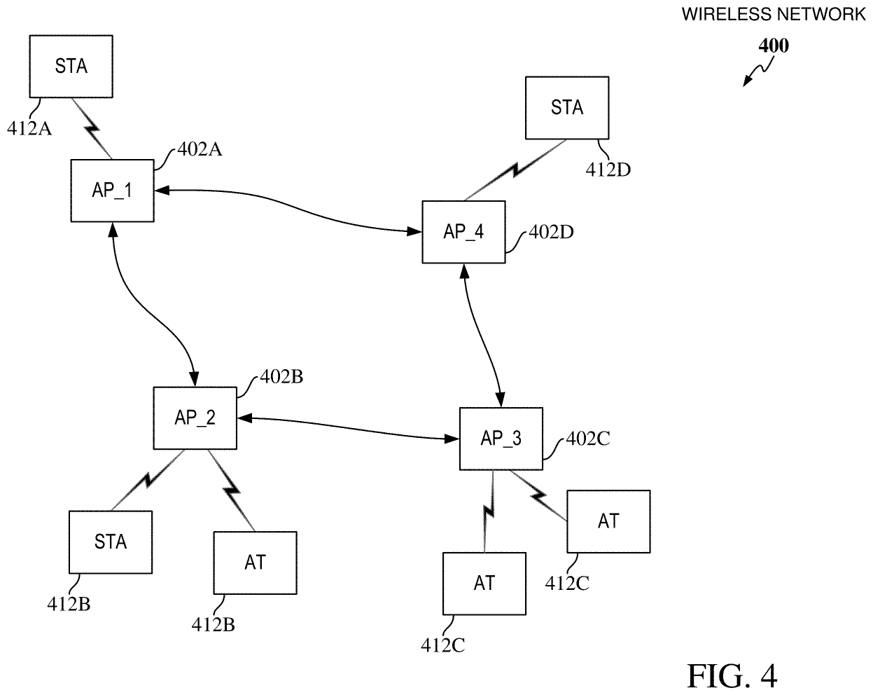

FIG. 4 illustrates a wireless network 400 such as a WLAN that may be used to describe various aspects of the present disclosure. The wireless network 400 includes a group of APs associated therewith, and are authorized to communicate therein, including an AP_1 402A, an AP_2 402B, an AP_3 402C, and an AP_4 402D. As illustrated, each authorized AP supports at least one STA that communicates therewith to access the wireless network 400. For example, the AP_1 402A supports an STA 412A, a pair of STAs 412B communicates with the AP_2 402B, the AP_3 402C supports a pair of STAs 412C, and the AP_4 402D supports an STA 412D. The wireless network 400 may be implemented as the MIMO network 100 of FIG. 1, above, and examples of the authorized APs and the STAs in the wireless network 400 may also be found in the description associated with the MIMO network 100 as well as the description of example APs and STAs in FIG. 2, and example wireless device in FIG. 3. Further, it should be noted that the wireless network 400 may implement a wireless mesh network.

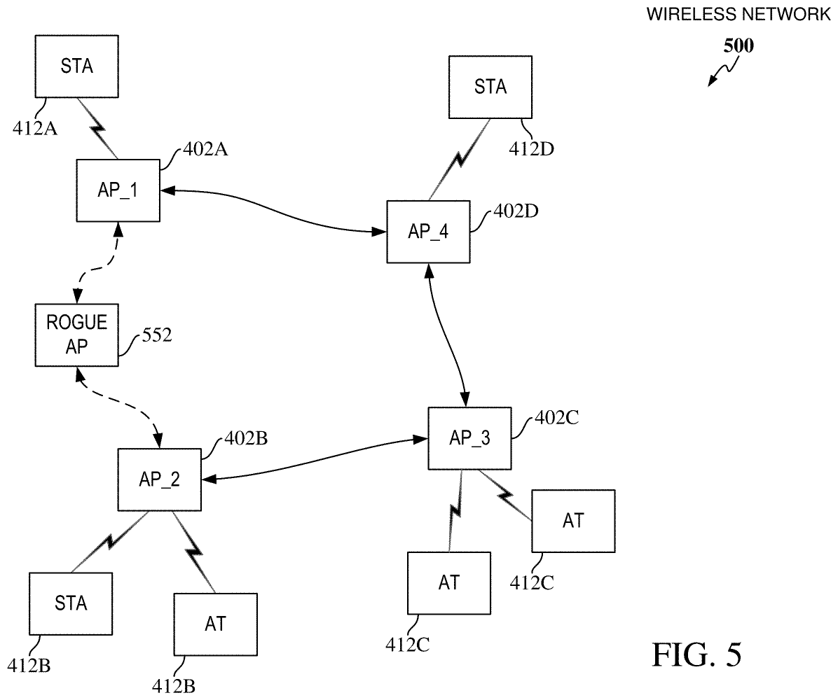

As noted above, a hacker may attempt to configure a fake AP to allow communication in a wireless network such as the wireless network 400. FIG. 5 illustrates a wireless network scenario 500 in which a RAP 552 has been inserted into the wireless network 400. The RAP 552 may be placed there in an attempt to impersonate the AP_1 402A and/or the AP_2 402B and either intercept the communications therebetween or otherwise gain access to the wireless network 400.

The following examples of apparatuses, methods, computer-readable mediums, wireless nodes, and wireless devices effectively: (1) monitor wirelessly transmitted packets from various wireless nodes, including those that maybe either authorized APs or RAPs; (2) compare a received packet claiming to be transmitted by an authorized AP to packets known to have been transmitted from authorized APs; and (3) generate an alert if the received packet does not match any packets known to have been transmitted from the authorized APs. Each authorized AP stores all packets that it transmits to the wireless network to a cloud-based, remote packet storage. Only authorized APs may access the remote packet storage to store or retrieve information from the remote packet storage, as further described herein.

In one aspect of the present disclosure, a monitoring mechanism (which may also be referred to a RAP detection mechanism) on a wireless device may be used to receive packets over a WLAN. The wireless device may function as a dedicated RAP detection device (which may be referred to simply as a “monitor” or a “monitor device”) that does not perform any wireless transmissions, nor does it have to function like an AP. The packets received by the monitor may be transmitted from a wireless node such as an RAP or an authorized AP, and it is important to detect if they have been transmitted by the RAP. Normally, even if it is the RAP that transmits the packets, they may spoof, or imitate, packets that would be transmitted from the authorized AP. To detect if the packets are transmitted from the RAP—and, thereby detect the presence of the RAP attempting to communicate in the WLAN—the monitoring mechanism may compare the received packets to packets retrieved from the remote packet storage. The retrieved packets are known to be “authentic” as they have been stored in the packet storage by authorized APs using secure communications links not available to unauthorized wireless nodes such as the RAP. In other words, the retrieved packets are known to be authentic and associated with authorized APs because only these APs have the ability to store packets into the packet storage.

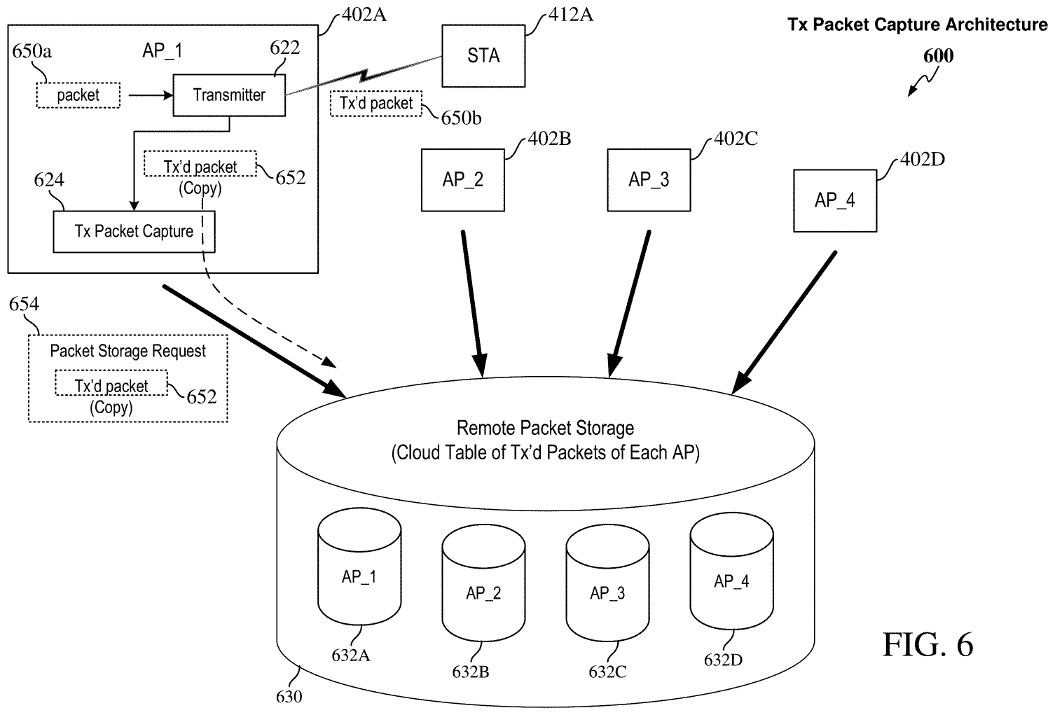

FIG. 6 illustrates a transmitted (Tx) packet capture and storage architecture 600 that may be used in various aspects of the present disclosure, including a remote packet storage 630 that includes a database for storing the Tx packets of each authorized AP in a wireless network such as wireless network 400. Reference to FIG. 7, which illustrates a Tx packet capture and storage process 700 that may be implemented by each authorized AP in accordance with various aspects of the present disclosure, will be made during the description of the Tx packet capture and storage architecture 600.

In one aspect of the present disclosure, the Tx packet capture and storage process 700 is enabled in all authorized APs to continuously collect and push Tx packets to a remote, cloud storage that may be implemented by the remote packet storage 630. The remote packet storage 630 maintains a Tx packet database for each associated AP in the wireless network 400. For example, the remote packet storage 630 includes an AP_1 Tx packet database 632A for storing the Tx packets of the AP_1 402A, an AP_2 Tx packet database 632B for storing the Tx packets of the AP_2 402B, an AP_3 Tx packet database 632C for storing the Tx packets of the AP_3 402C, and an AP_4 Tx packet database 632D for storing the Tx packets of the AP_4 402D.

Referring to FIG. 7 while still referring to FIG. 6, the AP_1 402A will be used to describe the Tx packet capture and storage process 700 where, at 702, the AP_1 402A will generate a packet 650a for transmission to another wireless node on the wireless network 400, such as another authorized AP. The packet 650a may be transmitted by a transmitter 622 in 402 as a Tx'd packet 650b and operation may then continue with 704.

At 704, a copy of the Tx'd packet 650b is created as a Tx'd packet (copy) 652 by a Tx packet capture module 624 in the AP_1 402A. In one aspect of the present disclosure, the Tx'd packet (copy) 652 is made after the packet 650a has been transmitted. For example, the Tx'd packet (copy) 652 may be made after the Tx packet capture module 624 receives confirmation from the transmitter 622 that the packet 650a has been successfully transmitted. As another example, the Tx'd packet (copy) 652 may be generated by the transmitter 622 after the packet 650a has been transmitted and provided to the Tx packet capture module 624.

The Tx packet capture module 624 is responsible for ensuring that the Tx'd packet (copy) 652 is stored in the remote packet storage 630. At 706, to access the remote packet storage 630, the Tx packet capture module 624 will establish a secure communications link with the remote packet storage 630. In one aspect of the present disclosure, the Tx packet capture module 624 may need to provide identity and security information to establish the secure communications link For example, the Tx packet capture module 624 may need to provide authentication information for the AP_1 402A as an authorized AP or otherwise the remote packet storage 630 will not allow access to ensure that the copies of Tx packets in its database is only from authorized APs. In addition, the Tx packet capture module 624 may need to provide identification information for the AP_1 402A to specifically access the AP_1 Tx packet database 632A in the remote packet storage 630. Once the secure communications link has been established, operation may then continue to 706.

At 706, the Tx packet capture module 624 may transmit a packet storage request 654 to store the Tx'd packet (copy) 652 along with the packet itself to the remote packet storage 630 over the secure communications link. In one aspect of the present disclosure, one or more of the authorized APs may be connected to communicate with the remote packet storage 630 using a wired network. Thus, similar to how an AP may be coupled to a network controller such as network controller 130 of FIG. 1 using a wired connection, one or more of the authorized APs may also be connected to the remote packet storage 630 using a wired connection. The use of a wired or wireless connection is purely a design choice, and those skilled in the art would understand that the specific implementation examples provided herein are not to be limiting on the scope of the applicability of the various aspects of the present disclosure.

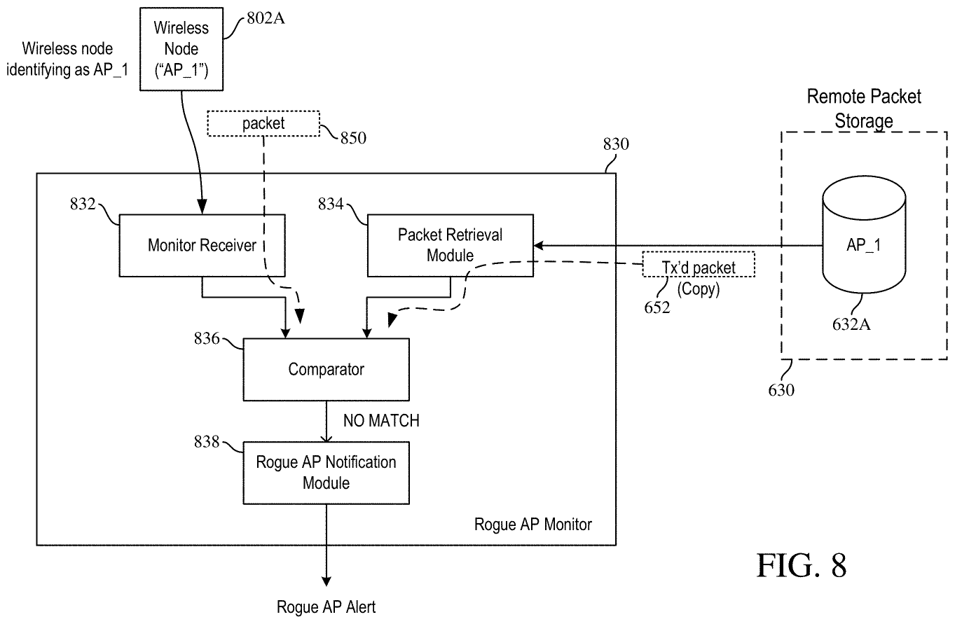

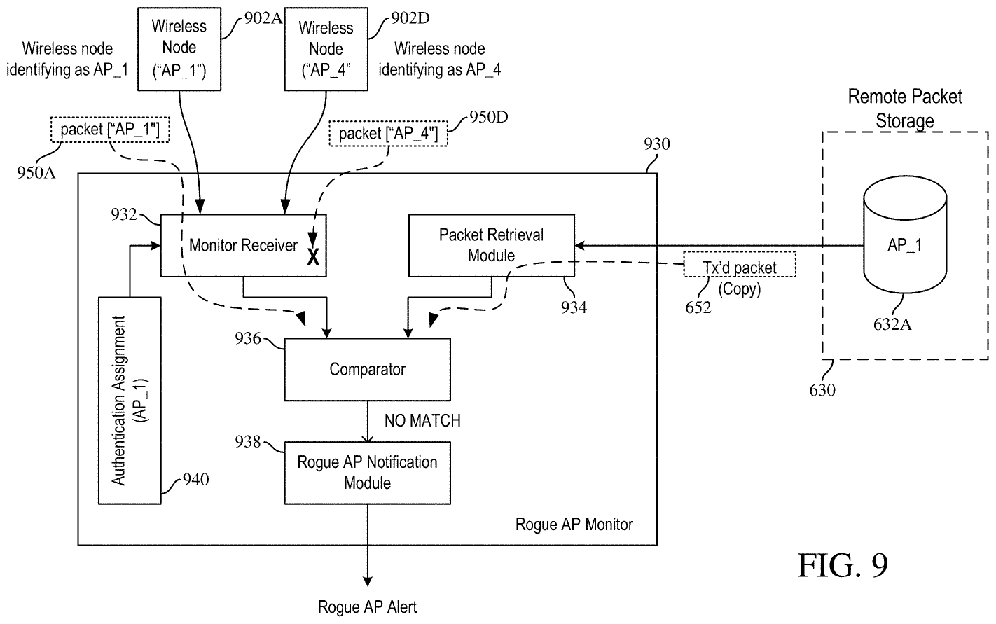

The Tx packet capture and storage process 700 may be repeated for each packet transmitted by each authorized AP. Thus, each authorized AP will include a Tx packet capture mechanism that captures a copy of each packet after it has been transmitted by the authorized AP, such as when the packet has been transmitted by a transmitter on the authorized AP. The Tx packet capture mechanism may then provide the copy of the packet to the remote packet storage. In other words, copies of each packet transmitted by each authorized AP in the network is captured using a Tx packet capture mechanism and pushed to a common package storage for the wireless network that is remote from the authorized APs. The remote packet storage may thus store previously transmitted packets for each authorized AP that may be used for detecting an RAP, as further described herein with reference to FIGS. 8 and 9.

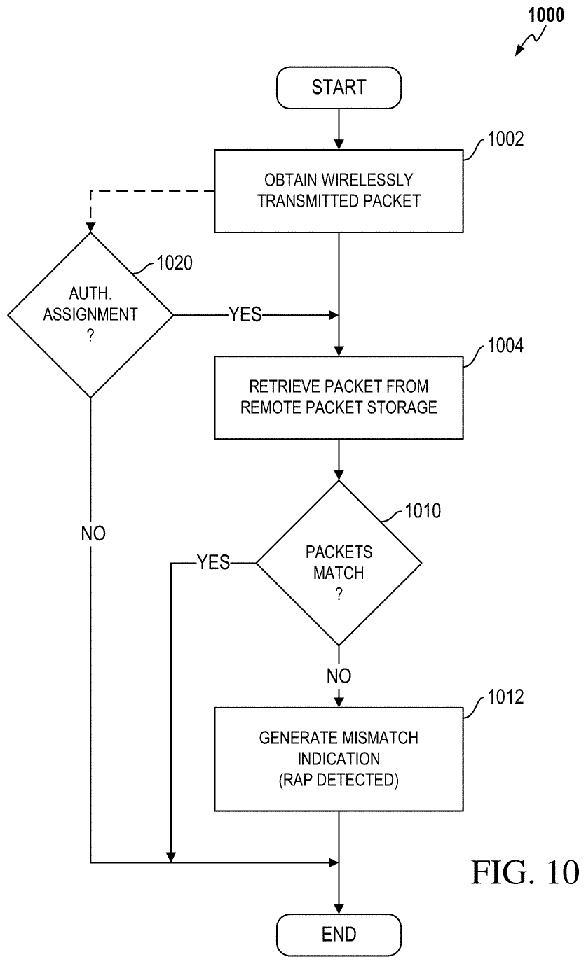

FIG. 8 illustrates an RAP monitor 830 that may be used as a dedicated RAP detection device in accordance with various aspects of the present disclosure for detecting RAPs, while FIG. 9 illustrates an RAP monitor 930 that may be used to provide RAP detection in a WLAN by distributing the RAP detection ability over multiple authorized wireless nodes in the WLAN, such as over two or more authorized APs. These figures illustrate at least two general approaches to allow RAP detection in accordance with various aspects of the present disclosure, as further discussed herein with reference to FIG. 10. However, it should be noted that these are not the only approaches to RAP detection that may be achieved using the various aspects of the present disclosure presented herein. For example, although the RAP monitor 830 may be described as a monitor (i.e., a dedicated RAP detection device), the RAP monitor 830 may be used in a single authorized AP to act as a monitor. Similarly, the RAP monitor 930 may be used to distribute the RAP detection ability configured in accordance with various aspects of the present disclosure over two or more dedicated RAP detection devices (i.e., two or more monitor devices).

Referring to FIG. 8 while also referring to FIG. 10, which illustrates an RAP detection process 1000, an example scenario will be used to describe various aspects of the present disclosure with regard to the first approach. The RAP detection process 1000 is implemented by the RAP monitor 830, which includes a monitor receiver module 832 that may be used to receive packets going over the air. In one aspect of the present disclosure, all packets going over the air are captured by the monitor receiver module 832 that implements a received (Rx) packet processing through a dedicated Rx monitor.

At 1002, the monitor receiver module 832 of the RAP monitor 830 will receive a wirelessly transmitted packet from a wireless node such as a wireless node 802A that identifies itself as an authorized AP. Specifically, the wireless node 802A identifies itself as the AP_1 402A in a packet 850. For example, the AP_1 402A will have an associated SSID and MAC address, and the packet 850 will include that information. However, as discussed above, the wireless node 802A may actually be an RAP that is spoofing an authorized AP (i.e., the AP_1 402A) because a hacker has forged the appropriate SSID and MAC address information in an attempt to access the wireless network 400. Thus, the RAP monitor 830 must determine whether the wireless node 802A is authorized to communicate within the network by examining the packet 850, as further described herein.

At 1004, a packet retrieval module 834 in the RAP monitor 830 will retrieve a packet from the remote packet storage 630, based on the packet 850, to use as an authentication packet. As used herein, the term “authentication packet” may refer to any packet that is used to confirm that the packet to which it is compared (e.g., the packet 850) has actually been transmitted by an authorized AP. Continuing with the scenario above, because the packet 850 indicated that it was sent by the AP_1 402A, the packet retrieval module 834 will attempt to retrieve at least one packet, from the remote packet storage 630, that is associated with the AP_1 402A. This retrieved packet may be used as an authentication packet and a determination is made to see if there is a match between the packet 850 and the authentication packet, as described in the next operation. In this specific example, the packet retrieval module 834 may retrieve the Tx'd packet (Copy) 652 that is stored in the AP_1 Tx packet database 632A in the remote packet storage 630.

In one aspect of the present disclosure, the retrieval of the authentication packet may be based on a request from the packet retrieval module 834 that may include a filter to limit or specify the packet(s) returned by the AP_1 Tx packet database 632A. For example, the filter may specify one or more of an identity of the authorized AP (i.e., each packet may have a source identifier of the wireless node from which it is transmitted), a packet length, or a packet transmission time. The retrieval request would then be transmitted by the packet retrieval module 834 to the remote packet storage 630, which would filter the appropriate AP Tx packet database (e.g., the AP_1 Tx packet database 632A) for packets to return. Thus, one or more packets may be returned for the next operation.

It should be noted that, in some cases, there may not be any packets returned from the retrieval request, especially if the wireless node 802A is actually an RAP and the authorized AP it tried to impersonate has not transmitted any packets that would match the search criteria. For example, if the authorized AP has not transmitted any packets within a certain amount of time, and the packet transmitted by the RAP is past that time. As another example, there are no packets matching the packet length of the packet to be checked. It should be apparent to those skilled in the art that one or more other filter criteria may be used in the retrieval request.

At 1010, the RAP monitor 830 may compare the packet 850 and the Tx'd packet (Copy) 652 using a comparator 836. If the packets match, then the RAP monitor 830 has confirmed that the packet 850 is transmitted from an authorized AP, which in this case means that the wireless node is 802A is the AP_1 402A. In one aspect of the present disclosure, the comparator 836 will determine whether there is a match by performing a bitwise correlation between the packet 850 and the Tx'd packet (Copy) 652. This ensures an absolute match between the packets because each bit has been compared on a bitwise basis. In other aspects, the comparator 836 may perform only partial correlation of the packets, such as only comparing a portion of the packets. A partial correlation is not preferable for optimal security. If the packet 850 and the Tx'd packet (Copy) 652 do not match, then operation continues with 1012.

At 1012, if the comparator 836 has determined that the packet 850 and the Tx'd packet (Copy) 652 do not match, then it will send an indication (or alert) signal to a RAP notification module 838. In one aspect of the present disclosure, the RAP notification module 838 may transmit an alert or alert signal to an application and notify a network administrator. In another aspect, the RAP notification module 838 may generate a notification packet to be transmitted to another wireless node, such as a management station. The notification packet may be sent using a wired network interface if the RAP monitor 830 does not have a wireless interface.

Now referring to FIG. 9 as well as continuing to refer to FIG. 10, in a second approach to detecting an RAP, packets going over the air are captured via a monitor receiver 932 in a RAP monitor 930 that may be implemented as part of an authorized AP such as on all APs in the network. The monitor receiver 932 performs Rx packet processing in monitor mode. In this approach, where there is no dedicated monitor, protection of each authorized AP may be distributed across other authorized APs to increase the efficiency of various aspects of RAP detection, such as cloud lookup and Rx packet filtering. The functionality and operation of the RAP monitor 930, as well the various modules contained therein, are similar to the RAP monitor 830 of FIG. 8 and follow the operation described therefor in FIG. 10, except as noted below. For example, in addition to the monitor receiver 932, the RAP monitor 930 includes a packet retrieval module 934, a comparator 936, and a RAP notification module 938 operate likewise to similarly numbered components in FIG. 8, including the packet retrieval module 834, the comparator 836, and the RAP notification module 838. Thus, the description provided for the RAP monitor 830 of FIG. 8 apply to the RAP monitor 930, except as described herein.

In accordance with various aspects of the present disclosure, in order for the distributed RAP detection to operate on multiple authorized APs, each authorized AP will be assigned one or more other authorized AP to monitor. Thus, for example, the RAP monitor 930 includes an authentication assignment module 940 that receives an assignment of one or more authorized APs, for which the RAP monitor 930 should perform RAP detection (i.e., each authorized AP is responsible for detecting an RAP trying to impersonate one or more authorized AP in a specified group of authorized APs). In one aspect of the present disclosure, each authorized AP is assigned one other authorized AP, and the authentication assignment module 940 controls when the RAP monitor 930 will operate to examine the received packet.

For example, returning to FIG. 10 and reviewing the example scenario illustrated in FIG. 9, a wireless node 902A and a wireless node 902D each transmits a packet that is received by the RAP monitor 930 at 1002. A packet 950A that is transmitted by the wireless node 902 identifies the wireless node as the AP_1 402A and a packet 950D that is transmitted by the wireless node 902D identifies the wireless node as the AP_4 402D. However, as applied to the operation of the RAP monitor 930, the RAP detection process 1000, after 1002, will continue to 1020 instead of 1004.

At 1020, the authentication assignment module 940 would determine that the RAP monitor 930 is to examine any packets received from any wireless node identifying itself as the AP_1 402A. Thus, operation would continue as described above with respect to the RAP monitor 830, with the packet retrieval module 934 to retrieve one or more authentication packets from the remote packet storage 630 to compare with the packet 950A because the wireless node 902A has identified itself as the AP_1 402A. However, the RAP monitor 930 will not examine or further process the packet 950D because it is associated with the AP_4 402D, the authentication assignment module 940 does not list that authorized AP as one for which the RAP monitor 930 is responsible.

In other various aspects of the present disclosure, the authentication assignment module 940 may be used to assign an RAP monitor such as the RAP monitor 930 more than one authorized AP, as noted above. Preferably, the distribution of the RAP monitoring should be balanced. However, use of an authentication assignment module such as the authentication assignment module 940 may allow any assignment scheme. Further, it is not inconceivable that a mix of dedicated RAP monitors and RAP monitors implemented as part of authorized APs may be used to detect RAPs.

Based on combination of packets stored in the packet storage by Tx packet capture and monitoring of Rx packets in the network, packets seen over the air from each authorized AP in the network is correlated against packets in the Tx capture database (i.e., the packet storage) for that particular AP to identify RAPs in the environment.

With the aforementioned solution, RAPs may be detected without requiring any dependency on packet characteristics or statistics, which may be circumvented by hackers. Moreover, there are no dependencies on STA-side RAP detection algorithms. Further, this type of a “generic” monitoring-based mechanism is not limited to any particular type of management packet and may be extended even for protecting against probe and association frames replicated by RAPs.

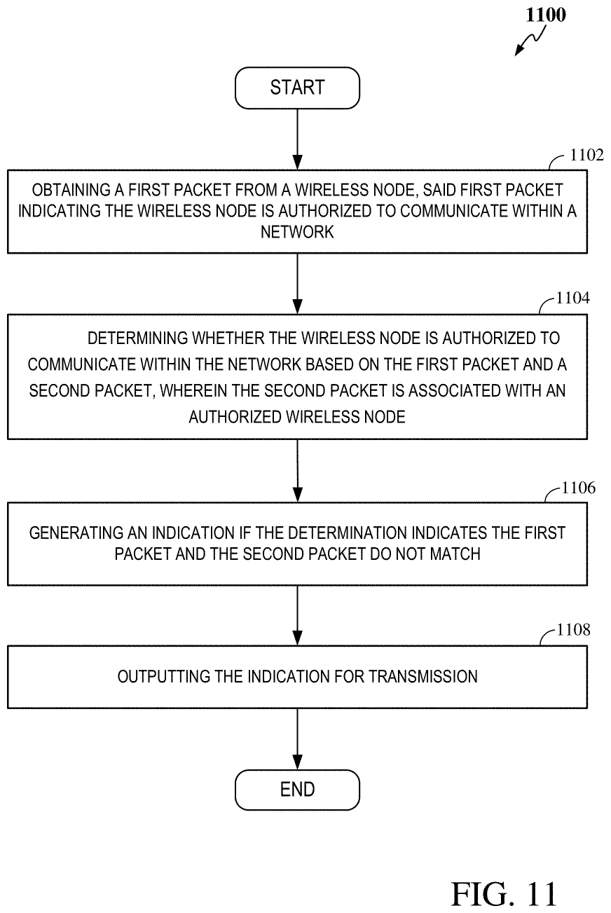

FIG. 11 illustrates a process 1100 for detecting an RAP that includes, in 1102, obtaining a first packet from a wireless node, the first packet indicating the wireless node is authorized to communicate within a network; in 1104, determining whether the wireless node is authorized to communicate within the network based on the first packet and a second packet, wherein the second packet is associated with an authorized wireless node; in 1106, generating an indication if the determination indicates the first packet and the second packet do not match; in 1108, of outputting the indication for transmission.

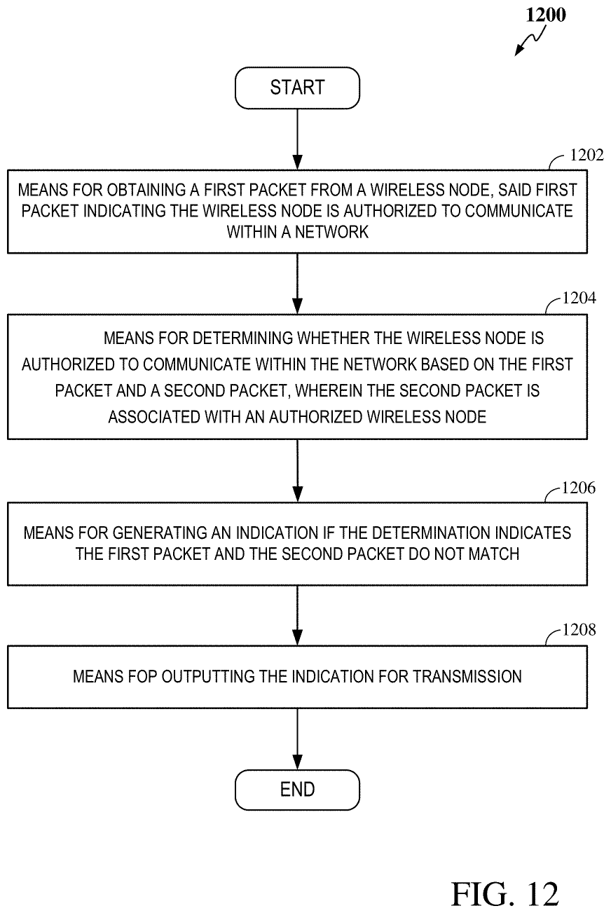

FIG. 12 illustrates an apparatus 1200 for detecting an RAP that includes: 1202, means for obtaining a first packet from a wireless node, the first packet indicating the wireless node is authorized to communicate within a network; 1204, means for determining whether the wireless node is authorized to communicate within the network based on the first packet and a second packet, wherein the second packet is associated with an authorized wireless node; 1206, means for generating an indication if the determination indicates the first packet and the second packet do not match; and 1208, means for outputting the indication for transmission.

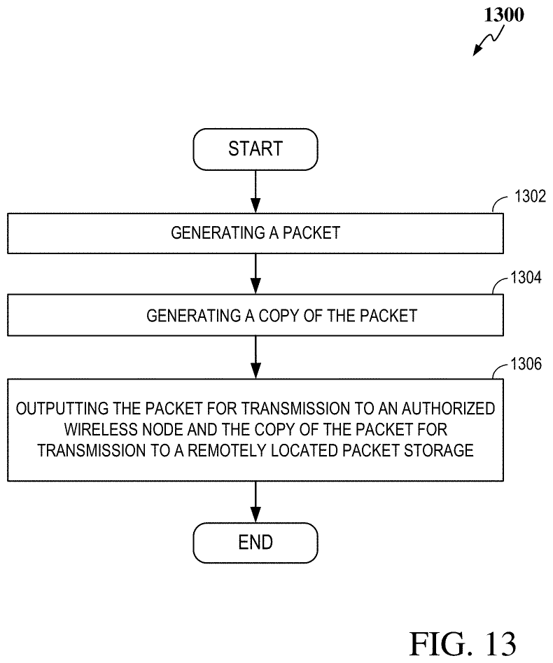

FIG. 13 illustrates a process 1300 for packet capture and storage that includes, in 1302, generating a packet; in 1304, generating a copy of the packet; and, in 1306, outputting the packet for transmission to an authorized wireless node and the copy of the packet for transmission to a remotely located packet storage.

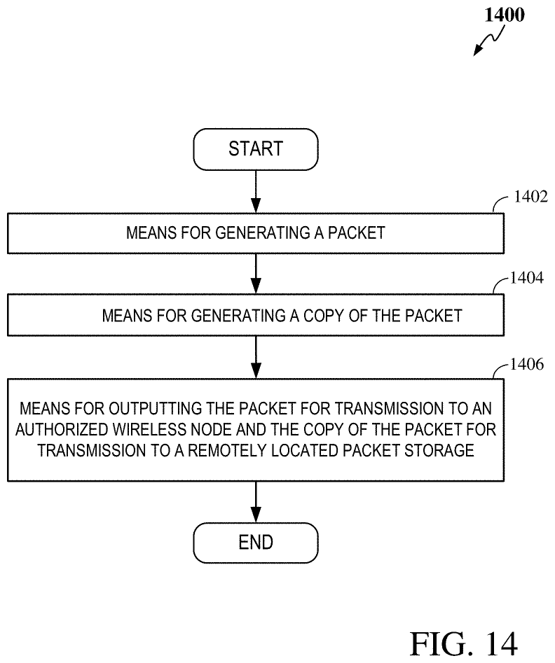

FIG. 14 illustrates an apparatus 1400 for transmitted packet capture and storage that includes: 1402, means for generating a packet; 1404, means for generating a copy of the packet; and 1406, means for outputting the packet for transmission to an authorized wireless node and the copy of the packet for transmission to a packet storage remotely located from the apparatus.

The methods disclosed herein include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. The term “retrieving” would also be similarly interpreted.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” For example, the articles “a” and “an” as used in this application and the appended claims should generally be construed to mean “one or more” unless specified otherwise or clear from the context to be directed to a singular form. Unless specifically stated otherwise, the term “some” refers to one or more. Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. More specifically, operations in the process 1100 illustrated in FIG. 11 correspond to means in the apparatus 1200 illustrated in FIG. 12. Further, operations in the process 1300 illustrated in FIG. 13 correspond to means in the apparatus 1400 illustrated in FIG. 14.

For example, means for transmitting (or means for outputting for transmission where the means does not encompass a chip) may include a transmitter (e.g., the transmitter unit 222) and/or an antenna(s) 224 of the access point 110 or the transmitter unit 254 and/or antenna(s) 252 of the station 120 illustrated in FIG. 2. Means for receiving (or means for obtaining) may include a receiver (e.g., the receiver unit 222) and/or an antenna(s) 224 of the access point 110 or the receiver unit 254 and/or antenna(s) 252 of the station 120 illustrated in FIG. 2. Means for determining, means for obtaining, means for generating, means for retrieving, means for performing, means for establishing, or any other means for taking one or more actions may include a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the station 120 illustrated in FIG. 2.

In some cases, rather than actually transmitting a frame, a device may have an interface to output a frame or a packet for transmission (a means for outputting). For example, a processor (or processing system) may output a frame, via a bus interface, to a radio frequency (RF) front end for transmission. Similarly, rather than actually receiving a frame or a packet, a device may have an interface to obtain a frame received from another device (a means for obtaining) For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may include a processing system in a wireless node, which may also be referred to as a wireless device or a monitor. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall network or system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communications media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, phase change memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may include a single instruction, or many instructions, and may be distributed over several different code segments, among different programs, and across multiple storage media. The computer-readable media may include a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may include non-transitory computer-readable media (e.g., tangible media). In addition, for other aspects computer-readable media may include transitory computer-readable media (e.g., a signal). Combinations of the above should also be included within the scope of computer-readable media.

Thus, certain aspects may include a computer program product for performing the operations presented herein. For example, such a computer program product may include a computer-readable medium having instructions stored (and/or encoded) thereon, the instructions being executable by one or more processors to perform the operations described herein. For example, instructions for performing the operations described herein and illustrated in the appended figures.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be used.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications comprising:
a processing system configured to:
obtain a first packet from a wireless node, said first packet indicating the wireless node is authorized to communicate within a network;
determine whether the wireless node is authorized to communicate within the network based on the first packet and a second packet, wherein the second packet is associated with an authorized wireless node; and
generate an indication if the determination indicates the first packet and the second packet do not match; and
an interface configured to output the indication for transmission.

2. The apparatus of claim 1, wherein the second packet comprises a packet that has previously been stored in the packet storage by the authorized wireless node or the wireless node.

3. The apparatus of claim 1, wherein the processing system is configured to retrieve, after obtaining the first packet, the second packet from a packet storage, wherein the retrieval of the second packet is based on a length of the first packet, and further wherein a length of the second packet is equal to the length of the first packet.

4. The apparatus of claim 1, wherein the first packet comprises a transmission time of the first packet, wherein the processing system is configured to retrieve, after obtaining the first packet, the second packet from a packet storage, wherein the retrieval of the second packet is based on the transmission time of the first packet, and further wherein a transmission time of the second packet is equal to the transmission time of the first packet.

5. The apparatus of claim 1, wherein the first packet comprises a source identifier, and the processing system is configured to retrieve the second packet from a packet storage based on the source identifier.

6. The apparatus of claim 1, wherein the determination comprises determining if the first packet and the second packet correlate with each other; and wherein the determination indicates the first packet and the second packet do not match if the first packet and the second packet do not correlate on a bitwise basis.

7. The apparatus of claim 1, wherein the indication comprises an alert signal indicating the wireless node is not authorized to communicate within the network.

8. (canceled)

9. The apparatus of claim 1, wherein the interface is configured to obtain an authentication assignment, and wherein the processing system is configured to perform the determination of whether the wireless node is authorized to communicate within the network only if the authentication assignment identifies the wireless node.

10. (canceled)

11. An apparatus for wireless communications comprising:
a processing system configured to:
generate a packet; and
generate a copy of the packet; and
an interface configured to output the packet for transmission to an authorized wireless node and the copy of the packet for transmission to a packet storage remotely located from the apparatus.

12. The apparatus of claim 11, wherein the processing system is further configured to establish a secure communications link with the packet storage, and wherein the interface is configured to output the copy of the packet for transmission to the packet storage after the secure communications link has been established.

13. The apparatus of claim 11, wherein the processing system is further configured to generate an identification of the apparatus, and wherein the interface is configured to output the identification along with the copy of the packet for transmission to the packet storage.

14. The apparatus of claim 11, wherein the processing system is further configured to:
obtain a first packet from a wireless node, said first packet indicating the wireless node is authorized to communicate within a network;
determine whether the wireless node is authorized to communicate within the network based on the first packet and a second packet, wherein the second packet is associated with an authorized wireless node; and
generate an indication if the determination indicates the first packet and the second packet do not match,
wherein the interface is further configured to output the indication for transmission.

15. The apparatus of claim 14, wherein the second packet comprises a packet that has previously been stored in the packet storage by the authorized wireless node or the wireless node.

16. The apparatus of claim 14, wherein the processing system is configured to retrieve, after obtaining the first packet, the second packet from a packet storage, wherein the retrieval of the second packet is based on a length of the first packet, and further wherein a length of the second packet is equal to the length of the first packet.

17. The apparatus of claim 14, wherein the first packet comprises a transmission time of the first packet, wherein the processing system is configured to retrieve, after obtaining the first packet, the second packet from a packet storage, wherein the retrieval of the second packet is based on the transmission time of the first packet, and further wherein a transmission time of the second packet is equal to the transmission time of the first packet.

18. The apparatus of claim 14, wherein the first packet comprises a source identifier, and the processing system is configured to retrieve the second packet from a packet storage based on the source identifier.

19. The apparatus of claim 14, wherein the determination comprises determining if the first packet and the second packet correlate with each other; and wherein the determination indicates the first packet and the second packet do not match if the first packet and the second packet do not correlate on a bitwise basis.

20. The apparatus of claim 14, wherein the indication comprises an alert signal indicating the wireless node is not authorized to communicate within the network.

21. (canceled)

22. The apparatus of claim 14, wherein the interface is configured to obtain an authentication assignment, and wherein the processing system is configured to perform the determination of whether the wireless node is authorized to communicate within the network only if the authentication assignment identifies the wireless node.

23-70. (canceled)

71. A wireless device, comprising:
a processing system configured to:
obtain a first packet from a wireless node, said first packet indicating the wireless node is authorized to communicate within a network;
determine whether the wireless node is authorized to communicate within the network based on the first packet and a second packet, wherein the second packet is associated with an authorized wireless node; and
generate an indication if the determination indicates the first packet and the second packet do not match; and
a transmitter configured to transmit the indication.

72. (canceled)

73. The apparatus of claim 1, wherein the processing system is further configured to:
generate a third packet; and
generate a copy of the third packet;
wherein the interface is configured to output the third packet for transmission to the authorized wireless node and the copy of the third packet for transmission to a packet storage remotely located from the apparatus.
